(19) United States
(12) Patent Application Publication
(10) Pub. No.: US 2022/0118572 A1
(43) Pub. Date: Apr. 21, 2022

(54) TILE SAW SPLASH GUARD AND RESERVOIR SYSTEM

(71) Applicant: Matthew BLAZEKOVICH, Apache Junction, AZ (US)

(72) Inventor: Matthew BLAZEKOVICH, Apache Junction, AZ (US)

(21) Appl. No.: 17/502,643

(22) Filed: Oct. 15, 2021

Related U.S. Application Data
(60) Provisional application No. 63/092,115, filed on Oct. 15, 2020.

(51) Int. Cl. B23Q 11/08; B23D 59/02; B28D 1/04

(52) U.S. Cl. CPC B23Q 11/08; B28D 1/04; B23D 59/025

(57) ABSTRACT

A tile saw splash guard and reservoir system has a splash guard, a water reservoir, a pump and tubing for use on a tile wet saw. Water from the tray of the saw spills over into the reservoir and is pumped to the cutting blade to lubricate the blade. The splash guard directs overspray and spillage of water and sediment into the reservoir. Some embodiments have a spillover tube at the drain hole of the tray. Sediment from cut tile settles to the bottom of the reservoir, allowing clean water to be pumped. The system keeps the work area clean and extends the amount of time a conventional tile saw may be used before having to be cleaned.

This application claims priority to U.S. Provisional Patent Application entitled “TILE SAW SPLASH GUARD AND RESERVOIR SYSTEM,” Ser. No. 63/092,115, filed Oct. 15, 2020, the disclosure of which is hereby incorporated entirely herein by reference.

### BACKGROUND OF THE INVENTION

### Technical Field

This invention relates generally to tile saws and particularly to a tile saw splash guard and reservoir system.

### State of the Art

Commercially-available tile saws, also known as “wet saws” or “wet tile saws”, such as are commonly used by tile installation contractors, typically comprise an electric motorized circular cutting blade mounted to a stand or supportive framework. The blade generally rotates in a vertical plane. The tile is normally laid on a horizontal sliding platform configured to slide under the cutting blade. The tile may then be cut as the user slides the sliding platform under the blade.

Water is commonly used as a blade lubricant. Many tile saws further comprise a tray for holding water. The tray is typically mounted to the stand or supportive framework below the sliding platform. Water may be pumped from the tray and directed to the cutting blade, while in use, to lubricate the blade. Some of the water then drips off the blade, down to the tile, and then rolls over an edge of the tile and back into the tray. The tray is intended to recapture a portion of the water for recirculation.

A common problem is that, as the cutting blade spins, water is sprayed from the cutting blade. A significant amount of the water sprayed from the cutting blade is directed through the air from the rear side of the saw. As tile is cut, the sprayed water also contains residue from the cut tile. Another problem is that, when a piece of tile is laid on the sliding platform, an edge of the tile may protrude further than the tray, so that the tray does not catch water dripping over the edge of the tile and onto the floor. This water also includes residue from cut tile. Water and tile residue spraying out from the back of the tile saw and dripping onto the floor creates a messy and unsafe work environment. It may also cause water damage and staining to walls, floors, and other materials near the saw. For these reasons, many tile installation contractors often use tile saws outdoors only, in an area where water damage is of no concern. However, for many tile jobs, setting up and using a tile saw outdoors is impractical, such as where the workspace is on a second floor of a building, or higher up within the building. For use indoors, or in other areas sensitive to water and tile residue, some users have resorted to blocking sprayed and dripping water and tile residue by using tarps to protect sensitive materials in the work environment.

An additional problem is that, with use of a conventional tile saw, residue from cut tile builds up in the tray. The residue tends to cloud the water in the tray over time until the water becomes muddy. The residue also tends to clog the water line (hose) and pump, as water is pumped from the tray to the blade. Furthermore, water is lost as it is sprayed from the saw and dripped onto the floor. For these reasons, it is necessary for a user to frequently stop work to empty and clean the tray, clean the saw, and replenish water in the tray—even several times throughout a single workday—resulting in increased cost due to lost time on a job.

Accordingly, what is needed is a means of preventing water and tile residue from being sprayed from a tile saw and from dripping onto the floor during use of the saw, as well as a means of conserving and recirculating clean water to the saw blade.

### SUMMARY OF THE INVENTION

The present invention relates to tile saws and particularly to a tile saw splash guard and reservoir system.

Embodiments of a tile saw splash guard and reservoir system configured to be coupled to a tile saw may comprise a splash guard, a water reservoir, a pump and tubing. Some embodiments may comprise a tile saw having a water tray, a splash guard, a water reservoir, a pump and tubing, and/or any other components of a tile saw splash guard and reservoir system, as described herein, coupled thereto. The reservoir is configured to contain a volume of water therein, and wherein a drain hole of a tray of a tile saw may be disposed over the reservoir such that water from the tray may spill into the reservoir through the drain hole.

The splash guard comprises a rear surface, and, in some embodiments, left and right side surfaces, and a top surface, configured to catch a spray of water and/or sediment from the tile saw blade and direct it to fall into the reservoir.

The pump may be disposed within the reservoir, and, at least partially, submerged under the surface of the water in the reservoir, and supported a predetermined distance above the bottom of the reservoir, to pump water through tubing to the cutting blade of the tile saw for lubrication of the blade. This allows sediment in the reservoir to settle to the bottom of the reservoir to minimize sediment being pumped through the pump.

Some embodiments may comprise at least one side wing or front wing coupled to the tray, extending outward therefrom, and sloping downward toward the tray. The at least one side wing or front wing is configured to capture water and/or sediment that may drip from the sides of a piece of tile being cut, or from a sliding platform upon which the piece of tile is resting.

In some embodiments, the system may further comprise a spillover tube coupled to the water tray of the tile saw, wherein the spillover tube extends upward from and is coaxial with the drain hole of the tile saw tray. In such embodiments, tile sediment that falls into the tray, during operation of the tile saw, tends to settle to the bottom of the tray. As water builds up in the tray, the level of the water continues to rise until it begins to spill into the spillover tube and fall down into the reservoir below. In this way, a significant portion of the tile sediment is captured in the tray of the tile saw, leaving somewhat cleaner water only to spill over into the reservoir below.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in conjunction with the Figures, wherein like reference numbers refer to similar items throughout the Figures, and:

FIG. 1 is a perspective view of a tile saw splash guard and reservoir system in accordance with the invention;

FIG. 2 is a perspective view of a tile saw and water tray in accordance with the invention;

FIG. 3 is a perspective view of a tile saw splash guard and water tray in accordance with the invention;

FIG. 4 is a perspective view of a water reservoir in accordance with the invention;

FIG. 5 is a detailed view of tubing and a tile saw cutting blade in accordance with the invention; and

FIG. 6 is a perspective view of a side wing attached to a water tray in accordance with the invention.

### DETAILED DESCRIPTION OF EMBODIMENTS OF THE INVENTION

As discussed above, embodiments of the present invention relate to tile saws and particularly to a tile saw splash guard and reservoir system.

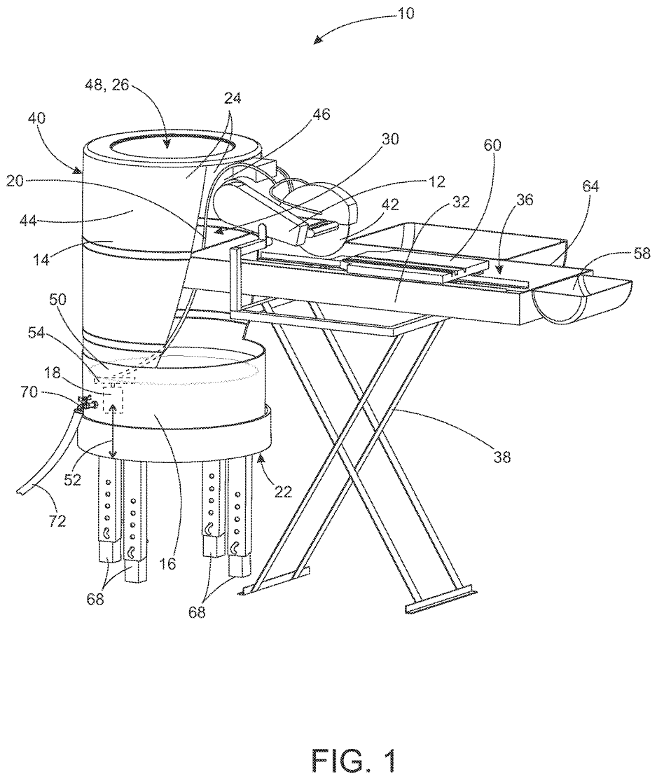

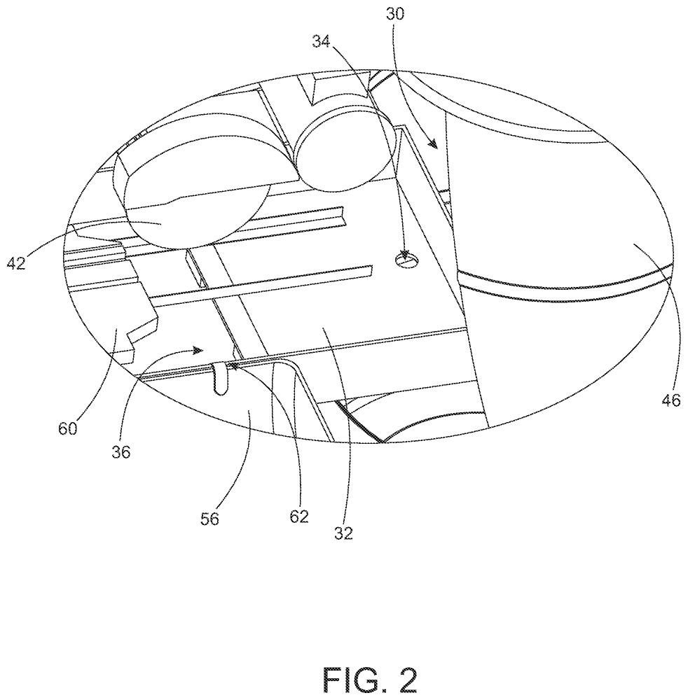

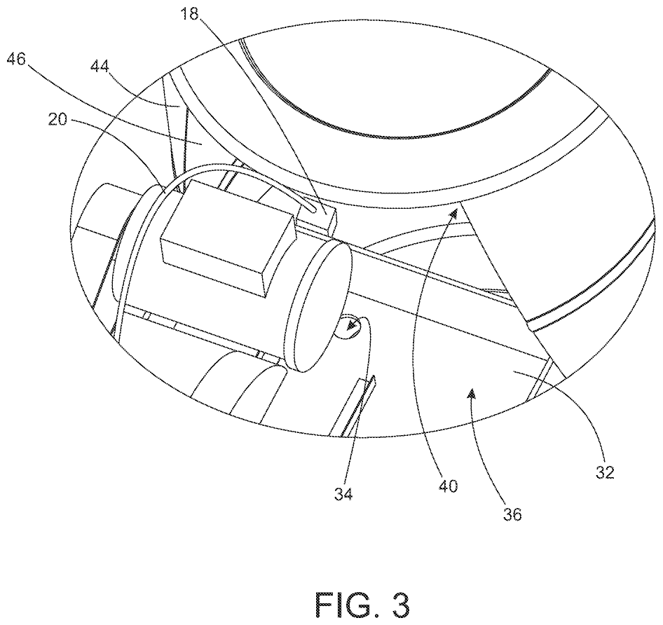

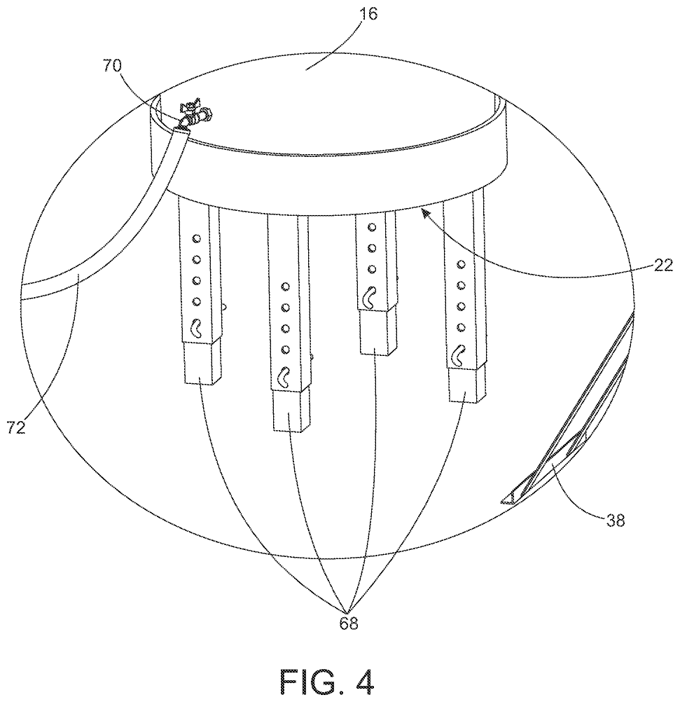

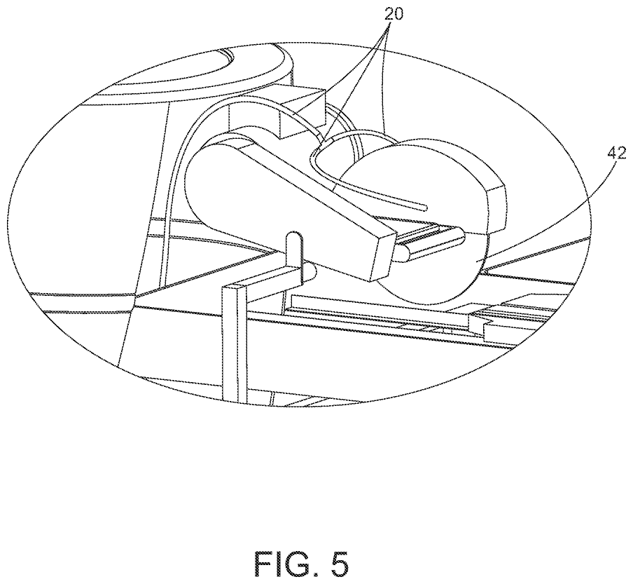

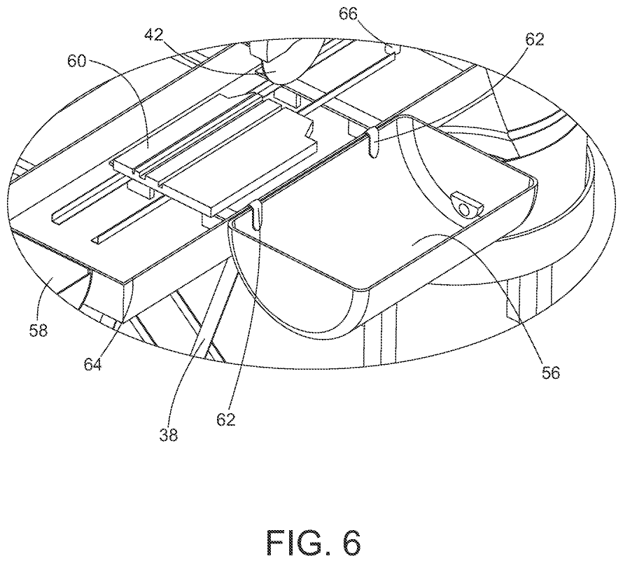

Referring to FIGS. 1-6, embodiments of a tile saw splash guard and reservoir system 10 may be configured to be coupled to a tile saw 12, wherein the system 10 may comprise a splash guard 14, a water reservoir 16, a pump 18 and tubing 20. Some embodiments may comprise a tile saw 12 having a water tray 32, a splash guard 14, a water reservoir 16, a pump 18 and tubing 20, and/or any other components of a tile saw splash guard and reservoir system 10, as described herein, coupled thereto.

In some embodiments, a reservoir 16 may be cylindrical, or barrel-shaped, having a closed bottom 22, a tubular side wall 24, and a closed top 26, the reservoir 16 being configured to contain a volume of water therein. The side wall 24 may comprise an opening 30 for partially receiving a tray 32 of a tile saw 12 therethrough, wherein a drain hole 34 in a bottom surface 36 of the tray 32 is disposed over the bottom 22 of the reservoir 16 to allow water to drain from the tray 32, through the drain hole 34, and into the reservoir 16. However, this is not intended to be limiting. A reservoir 16 may be of any shape, so long as it is configured to contain a volume of water therein, and wherein a drain hole 34 of a tray 32 of a tile saw 12 may be disposed over the reservoir 16 such that water from the tray 32 may spill into the reservoir 16 through the drain hole 34. For example, in some embodiments, the reservoir 16 may be a rectangular box-shaped reservoir 16, having an open top and resting either on the ground or on a support framework 38 of a tile saw 12 below the tray 32.

In some embodiments, the system 10 may further comprise a stand or frame (not shown) coupled to and supporting the reservoir 16. In some embodiments, the system may comprise a plurality of legs 68 coupled to and supporting the reservoir 16. In some embodiments, the stand or frame or legs 68 may be adjustable in height, whereby the height of the reservoir 16 above the ground may be adjusted to accommodate different trays 32.

Although a reservoir 16, as described above may be cylindrical, this is not intended to be limiting. A reservoir 16 may be of any shape, so long as it is configured to hold a volume of water and be disposed under a drain hole 34 of a tray 32 of a tile saw 12, such that water from the tray 32 may spill into the reservoir 16 through the drain hole 34.

In some embodiments, the system 10 may further comprise a drain valve 70 coupled to the reservoir 16, whereby water in the reservoir 16 may be drained from the reservoir 16, such as for storage while not in use. Some embodiments may comprise a drain hose 72 coupled to and in fluid communication with the drain valve 70 for directing water drained from the reservoir 16 to a desirable location away from the reservoir 16.

A splash guard 14 of the present invention, comprises at least a rear surface 40 configured to be disposed substantially vertically behind a tile saw 12 and over the reservoir 16, such that water that is sprayed from the back of the tile saw cutting blade 42 impacts the rear surface 40 and then falls or is directed into the reservoir 16. Some embodiments of a splash guard 14 may also comprise a left side surface 44 and a right side surface 46, each coupled to the rear surface 40 and disposed substantially vertically at either side of the tile saw 12, respectively, and over the reservoir 16 to similarly catch side spray from the tile saw 12 and direct it to fall into the reservoir 16. Some embodiments of a splash guard 14 may further comprise a top surface 48 coupled to the rear surface 40 and disposed substantially horizontally over the tile saw 12 to block any spray directed upward from the tile saw 12 and direct it downward to any of the tile saw 12, the tray 32, the reservoir 16, the rear surface 40 and/or the left and right side surfaces 44 and 46. In some embodiments, a splash guard 14 comprising any of the rear surface 40, the left side surface 44, the right side surface 46, and the top surface 48 may be of unitary construction. In other embodiments any of the rear surface 40, the left side surface 44, the right side surface 46, and the top surface 48 may be integrated as individual components forming a splash guard 14. In some embodiments, the splash guard 14 and reservoir 16 may be of unitary construction. In other embodiments, the splash guard 14 and reservoir 16 may be individual components.

A pump 18 of the present invention, may be disposed within the reservoir 16, and, at least partially, submerged under the surface 50 of the water in the reservoir 16, to pump water through tubing 20 to the cutting blade of the tile saw 12 for lubrication of the blade 42. The tubing 20 may be any suitable tubing 20 or piping coupled between the pump 18 and the cutting blade 42 for conducting water from the pump 18 to the cutting blade 42. In a preferred embodiment, the tubing 20 is forked to supply water for lubrication to both sides of the blade 42. The pump 18 may be supported a predetermined distance 52 above the bottom 22 of the reservoir 16. This allows sediment in the reservoir 16 to settle to the bottom 22 of the reservoir 16 to minimize sediment being pumped through the pump 18. Some embodiments may comprise a filter device 54 coupled to or disposed around the pump 18 for filtering sediment from water entering the pump 18.

Some embodiments may comprise at least one side wing 56 and/or front wing 58 coupled to the tray 32, extending outward therefrom, and sloping downward toward the tray 32. The at least one side wing 56 and/or front wing 58 is configured to capture water and/or sediment that may drip from the sides of a piece of tile being cut, or from a sliding platform 60 upon which the piece of tile is resting. The at least one side wing 56 and/or front wing 58 effectively extends the footprint area of the tray 32 for catching excess drippage, that would otherwise miss the tray 32 and fall to the ground or floor beneath the tile saw 12, and direct it into the tray 32. In some embodiments, the at least one side wing 56 and/or front wing 58 may be of unitary construction. In other embodiments, the at least one side wing 56 and/or front wing 58 may be individual components.

Each of the at least one side wing 56 and/or front wing 58 may be coupled to the tray 32 by any of a variety of suitable means. For example, each of the at least one side wing 56 and/or front wing 58 may comprise a slot 62 therein for receiving the outer rim 64 of the tray 32 into. In such embodiments the at least one side wing 56 and/or front wing 58 may be easily coupled to the tray 32 by a user simply sliding the slot 62 thereof over the rim 64. For removal, the user may simply lift it off the rim 64 of the tray 32. Some embodiments may comprise any of a variety of suitable mounting hardware for securing the at least one side wing 56 and/or front wing 58 to the tray 32.

In some embodiments, any of the at least one side wing 56 and/or the front wing 58 may be a basin 56 and/or 58 for catching spilled-over water. In some such embodiments, water captured in the basin 56 and/or 58 may be directed through piping or tubing to drain into the reservoir 16.

In some embodiments, the system 10 may further comprise a spillover tube 66 coupled to the drain hole 34 of the tile saw 12, wherein the spillover tube 66 extends upward from and is coaxial with the drain hole 34 of the tray 32. In such embodiments, tile sediment that falls into the tray 32, during operation of the tile saw 12, tends to settle to the bottom 36 of the tray 32. As water builds up in the tray 32, the level of the water continues to rise until it begins to spill into the spillover tube 66 and fall down into the reservoir 16 below. In this way, a significant portion of the tile sediment is captured in the tray 32 of the tile saw 12, leaving somewhat cleaner water only to spill over into the reservoir 16 below. Much of any sediment that does fall into the reservoir 16 below tends to settle to the bottom 22 of the reservoir 16, leaving much cleaner water only to be pumped through the pump 18 proximate the surface 50 of the water in the reservoir 16.

The components defining any tile saw splash guard and reservoir system may be formed of any of many different types of materials or combinations thereof that can readily be formed into shaped objects provided that the components selected are consistent with the intended operation of a tile saw splash guard and reservoir system. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as copper, zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any tile saw splash guard and reservoir system may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g., a bolt, a nut, a screw, a nail, a rivet, a pin, and/or the like), wiring, sewing, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A combination tile saw splash guard and reservoir system comprising:
a reservoir having a side wall, a drain valve and an opening configured for partially receiving a water tray of a tile saw;
a pump disposed within the reservoir;
tubing coupled to the pump, wherein the pump is configured to pump water through the tubing; and
a tile saw splash guard coupled to the reservoir and having a rear surface.

2. The combination of claim 1, wherein the reservoir comprises a closed top.

3. The combination of claim 1, wherein the reservoir comprises a closed bottom.

4. The combination of claim 1, wherein the side wall of the reservoir is a tubular side wall.

5. The combination of claim 1, wherein the pump is supported at a predetermined distance above a bottom of the reservoir.

6. The combination of claim 1, further comprising a filter device coupled to or disposed about the pump.

7. The combination of claim 1, further comprising a plurality of legs coupled to the reservoir.

8. The combination of claim 1, further comprising a drain hose coupled to the drain valve.

9. The combination of claim 1, wherein the tile saw splash guard further comprises a right side surface, a left side surface and/or a top surface.

10. The combination of claim 1, wherein the reservoir and the tile saw splash guard are of unitary construction.

11. A combination tile saw, tile saw splash guard and reservoir system comprising:
a tile saw disposed over a reservoir, the tile saw having a cutting blade and a water tray, the water tray having a drain hole;
the reservoir having a side wall, a drain valve and an opening configured for partially receiving the water tray;
a pump disposed within the reservoir;
tubing coupled to the pump, wherein the pump is configured to pump water through the tubing; and
a tile saw splash guard coupled to the reservoir and having a rear surface, wherein the rear surface of the tile saw splash guard is disposed vertically behind the tile saw and over the reservoir.

12. The combination of claim 11, wherein the tubing is forked about the cutting blade.

13. The combination of claim 11, further comprising at least one side wing and/or front wing coupled to the water tray, wherein the at least one side wing and/or front wing extends outward from the water tray, sloping downward toward the water tray.

14. The combination of claim 11, further comprising a spillover tube coupled to the tile saw, wherein the spillover tube extends upward from and coaxial with the drain hole of the water tray.

15. The combination of claim 11, wherein the pump is supported at a predetermined distance above a bottom of the reservoir.

16. The combination of claim 11, further comprising a filter device coupled to or disposed about the pump.

17. The combination of claim 11, further comprising a plurality of legs coupled to the reservoir.

18. The combination of claim 11, further comprising a drain hose coupled to the drain valve.

19. The combination of claim 11, wherein the tile saw splash guard further comprises a right side surface, a left side surface and/or a top surface.

20. The combination of claim 11, wherein the at least one side wing and/or front wing comprises a slot therein for receiving an outer rim of the water tray.
